(19) United States
(12) Patent Application Publication
(10) Pub. No.: US 2026/0116453 A1
(43) Pub. Date: Apr. 30, 2026

(54) WAGON WITH DETACHABLE FOLDING CHAIRS

(71) Applicant: Evenflo Company Inc., Miamisburg, OH (US)

(72) Inventors: Jeremy CROSSGROVE, Revere, MA (US); Gaylen ERCANBRACK, Plymouth, MA (US); Guangyao LI, Kunshan City (CN); Minghao LU, Kunshan City (CN); Jessica POPELKA, Charlotte, NC (US); Michelle M.J. WOOD, Rehoboth, MA (US)

(21) Appl. No.: 18/932,271

(22) Filed: Oct. 30, 2024

(51) Int. Cl. B62B 7/14

(52) U.S. Cl. CPC B62B 7/142

(57) ABSTRACT

A wagon may be configured to receive one or a pair of detachable chairs. Each chair may comprise a seat and a support that is moveable between a stored position and a deployed position, and at least one connector for removably attaching the chair to the wagon. One or more joint hubs may be used to rotatably connect the seat portion and the support together, and may also include a backrest that can rotate between several positions. The chair with the support in the deployed position may rest upon a flat surface such as the ground so that its seating surface is inclined relative to the flat surface. The chair may be sat upon while attached to the wagon with its backrest in a first position, and the backrest may be movable to a second position to reduce its profile when the wagon is in a collapsed state.

### BACKGROUND

Wagons are used to transport a variety of objects, with some also being configured to safely and comfortably transport children. Wagons may be used to bring children and objects to locations where seating is not already present, such as a beach or picnic area. Conventional wagons may be used to transport conventional seating, such as fixed or folding chairs or stools, to such locations but at the cost of taking up space in the wagon that might otherwise be used to transport other objects or children.

### BRIEF DESCRIPTION OF THE DRAWINGS

The present disclosure is described in detail below with reference to these figures.

FIG. 1 illustrates a perspective view of a wagon with a pair of detachable chairs in accordance with the present disclosure.

FIG. 2 illustrates a perspective view of the wagon of FIG. 1 with one of the chairs in a detached position.

FIG. 3 illustrates a perspective view of the chair of FIG. 1 with its support frame in a stored position.

FIG. 4 illustrates a perspective view of the chair of FIG. 3 with its support frame in a deployed position.

FIG. 5 illustrates a lower perspective view of components of the chair of FIG. 3 with the support frame in the stored position.

FIG. 6 illustrates a different lower perspective of the components of FIG. 5 with the support frame in the deployed position.

FIG. 7 illustrates a side perspective of the chair of FIG. 3 with the support frame being depicted in the stored position, the deployed position, and in a transition position there between.

FIG. 8 illustrates the chair of FIG. 4 resting upon a flat surface.

FIG. 9 illustrates a side partial cutaway view of the wagon of FIG. 1.

### DETAILED DESCRIPTION

As briefly discussed above, wagons may be configured to transport objects, children, or a combination of both. In some situations, a wagon may be used to transport objects and children to locations where there is a lack of seating, such as a beach. While the wagon can be used to transport one or more conventional seating apparatuses, such as chairs or stool, space within the wagon is then occupied that might otherwise have been used to transport additional objects or children. A conventional chair or stool, even if designed to be foldable into a more compact configuration, may also be sized or dimensioned so that the fit within the wagon is awkward, further reducing the amount of space available for transporting other objects and children.

This detailed description is related to a wagon configured to receive one or a pair of detachable chairs. Each chair may comprise a seat and a support that is moveable between a stored position and a deployed position. The chair may also include at least one connector for removably attaching the chair to the wagon. One or more joint hubs may be used to rotatably connect the seat portion and the support together. In an example, a pair of joint hubs may be used, with each one rotatably connecting first and second sides of the seat and support.

In examples, the chair may further include a backrest, which may be connected to the seat and the support by the joint hubs. The backrest may be rotatable between folded, upright, and laid-back positions. In other examples, the backrest can be locked in a plurality of positions between the folded and laid-back positions.

The connector of each chair may be a post that can be received within a receptacle in or attached to the wagon. In an example, the post extends downwardly from the joint hub connecting the seat, the support and the backrest together. The receptacle may be attached to a part of the wagon at or near the bottom or floor of the wagon bed, such as the bottom frame. On or more additional connectors may also be attached to the backrest and can be received in corresponding receptacles on the wagon, which may be in or attached to a part of the wagon at or adjacent to the top edge of the wagon frame, such as the top frame. These additional connectors may mitigate vibrations and movement of the backrest relative to the wagon as the wagon traverses uneven ground, and may prevent pinching of body parts by maintaining a constant spacing.

Each chair may be positioned within the wagon so that their seating surfaces can be sat upon when the chair is secured in the wagon in the stored position. The wagon may comprise a footwell in the bottom of the wagon bed into which parts of the chair, such as one or more the ground-engaging portions of the chair, may be positioned into.

The footprint of the chair in the deployed configuration may greater than the footprint of the chair in the stored configuration to enhance stability, with front and back ground contact surfaces are positioned in front of and behind the seat and the backrest, respectively. A footprint is an area of space covered by the chair on a ground contact plane. When the support is properly deployed, the front and back ground contact surfaces will rest upon the ground or other surface but the posts extending from the chair will not. The seating portion may be angled relative to the ground in the deployed configuration, so that the chair is more comfortable and ergonomic. The chair may also be configured so that it is purposefully unstable when placed on the ground in an upright position but with the support in the stored position, which may discourage a user from attempting the use the chair without properly deploying the support.

In examples, one or more of the chairs may each have a canopy that extends from the backrest. The canopy may be folded and rotated so that it is stored behind the backrest, and can fit within the space between the backrest and the end sidewall of the wagon when the chair is attached to the wagon.

As used herein, the term “wagon” means a multi-wheeled conveyance having a support platform and at least one handle for pushing or pulling.

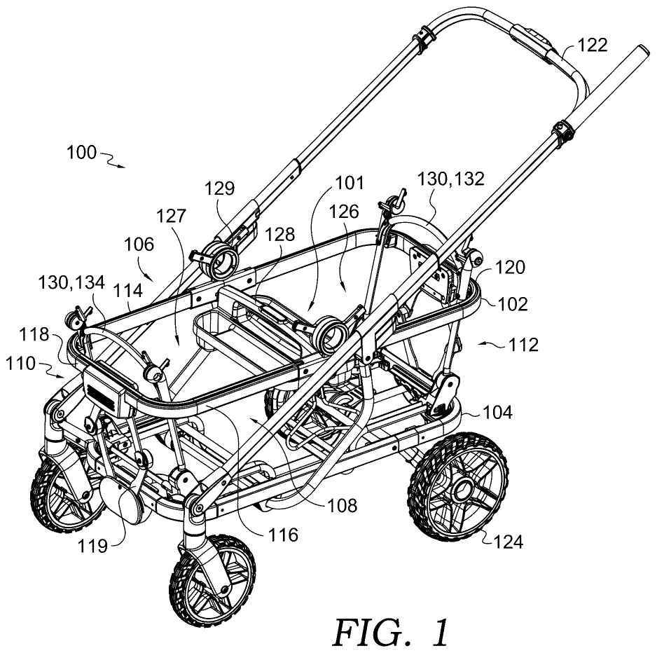

Turning now to FIG. 1, an example wagon 100 is provided. The wagon 100 may generally comprise a frame, which may include a top frame 102 and a bottom frame 104 that generally defines a first side 106, a second side 108 generally opposite the first side 106, a front side 110, and a rear side 112 generally opposite the front side 110. The top frame 102 may include a first frame portion 114 and a second frame portion 116 opposite the first frame portion 114. In instances, the top frame 102 includes a front frame portion 118 and a rear frame portion 120, each extending between the first frame portion 114 and the second frame portion 116. The bottom frame 104 of the wagon 100 may have frame portions corresponding to those of the top frame 102. The top frame 102 and the bottom frame 104 of the wagon 100 may be coupled to each other by one or more intermediate frame portions 119, which may be movable to allow the top frame 102 and the bottom frame 104 to collapse towards each other for storage. Additionally, the first frame portion 114 and the second frame portion 116 may be portions of a unitary structure or may be separately formed structures secured together either directly or indirectly via other components, such as the front frame portion 118 and the rear frame portion 120. The frame of the wagon 100 may be at least partially coupled to soft goods or other materials to form an enclosed or partially enclosed volume 101 of the wagon 100. For example, the volume 101 may be defined by soft goods forming sidewalls and a lower surface. The lower surface may be generally flat or may include features such as a footwell (further described below). In other examples, the wagon may be formed without a frame structure. For example, the wagon may comprise a self-supporting body that is molded or shaped from materials including, but not limited to, plastics, metals, or wood.

The wagon 100 may include a handle 122. The handle 122 is arranged to extend towards one end of the wagon 100 in this example and may act as a push or pull handle. In some aspects, the handle 122 may be adjustable so that it is movable between the front side 110 and the rear side 112 of the wagon 100 and useable for push or pull. The handle 122 may be movable relative to the frame through sliding, rotating, telescoping, pivoting, and the like. The handle 122 may be composed of two side handle portions and a central handle portion that connects the two side handle portions and provides a central area where a user would grasp the handle 122. In other examples, the handle 122 may comprise two side handle portions that are not joined together.

The frame may be coupled to wheels 124 allowing movement of the wagon 100. The wheels 124 are located at least partially under the frame such that the wheels support the weight of the frame. While four wheels 124 are shown, it will be appreciated that additional or fewer wheels 124 may be provided. For example, the wagon 100 may have a three-wheel configuration. The wheels 124 may be uniform in size or there may be differences in wheel sizes. For example, the rear wheels 124 may be larger in diameter than the front wheels 124.

Between the front side 110 and the rear side 112 of the frame may be a first seating area 126 configured to accommodate a person, such as a child. The first seating area 126 is generally positioned above the wheels 124. In the example shown in FIG. 1, a second seating area 127 may be located opposite of the first seating area 126. The wagon 100 may also include a canopy, which is not shown so as to avoid obstructing view of various components of the wagon 100. The canopy may be attached to the top frame 102 by rotating hub mechanisms 129 on the first frame portion 114 and the second frame portion 116. The canopy may provide weather protection for the occupant or occupants, such as UV protection from the sun. In aspects, the canopy may be collapsible and/or detachable.

The wagon 100 may include a tray 128. The tray 128 may provide an eating and activity surface for an occupant, such as a child. The tray 128 may allow the occupant to place and store items (e.g., snacks, toys, drinks) within the wagon 100. The tray 128 may extend between and be detachably coupled to the first frame portion 114 and the second frame portion 116. When the tray 128 is detached from the wagon 100, the occupant may have an increased range of motion such that the tray 128 does not restrict the occupant solely to the individual seating areas 126, 127. For example, when the tray 128 is detached, the occupant may easily move positions from the first seating area 126 to the second seating area 127 or the space in between. Additionally, when the tray 128 is detached from the wagon 100, the first seating area 126 and the second seating area 127 may be usable to accommodate larger occupants and/or larger items.

In some embodiments, the wagon 100 is collapsible between a collapsed position and a use position. The collapsed position may be a position in which the wagon 100 could be stored in the back of a vehicle or a closet, for example. One or more accessories, such as the canopy or tray 128, may be detached from the wagon 100 to improve the efficiency of the collapsibility of the wagon 100. The use position may be a position in which the wagon 100 could be pushed or pulled carrying an occupant, such as a child. In other examples, the wagon 100 is not collapsible.

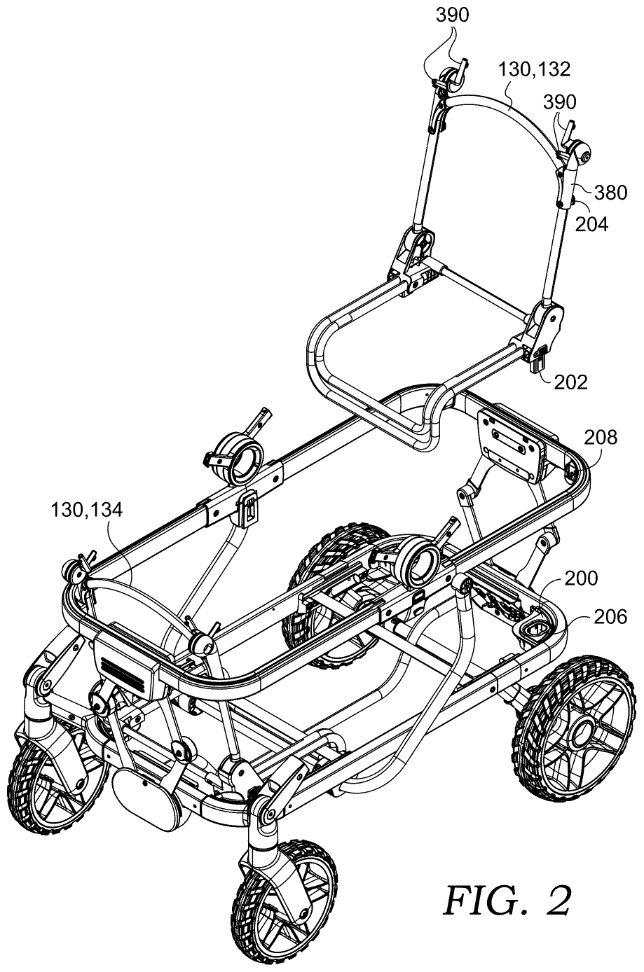

The wagon of FIG. 1 includes a pair of chairs 130. As seen in FIG. 2, each chair 130 can be removably attached to the wagon by aligning and inserting lower connectors 202 and upper connectors 204 on the chair 130 into complementary lower receptacles 200 and upper receptacles 208 attached to the frame of the wagon 100. In some examples, the connectors and receptacles may be integrally formed with components of the chair 130 (such as the joint hub 360) and the wagon 100 (such as the bottom frame 104) respectively. The seating areas 126, 127 may include soft goods, such as textiles and cushions, to aid in occupant comfort when the chairs 130 are not attached to the wagon 100 in the seating areas 126, 127, and may also include a harness, lap belt, or other features not illustrated that may be used with or without the chairs 130.

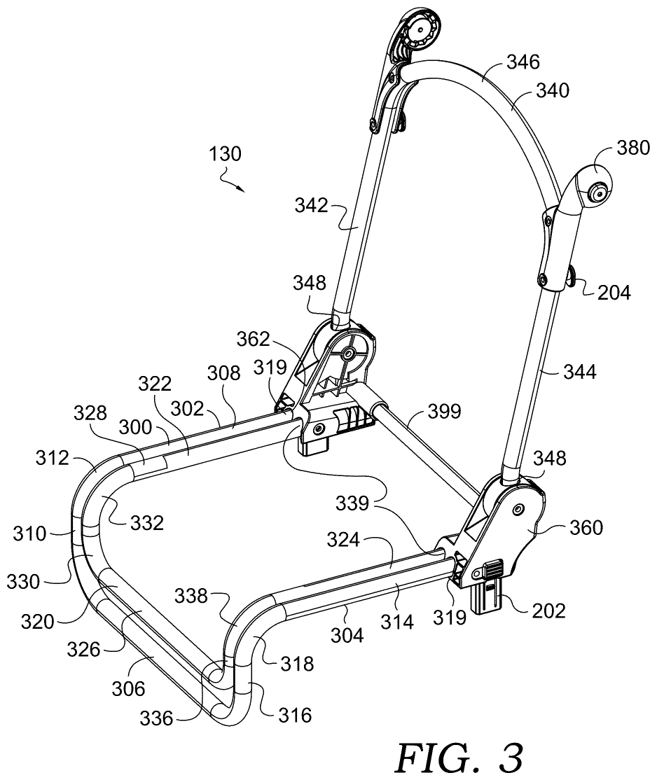

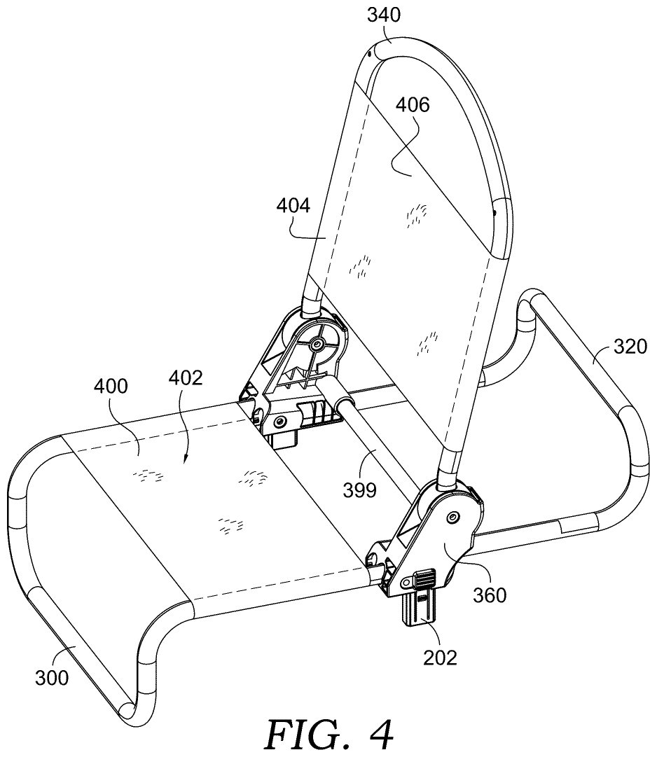

As shown in FIG. 3 and FIG. 4, the frame of each chair 130 comprises seat frame 300, a support frame 320, and a backrest frame 340, with a pair of joint hubs 360 connecting the seat frame 300, the support frame 320 and the backrest frame 340 to each other.

The seat frame 300 is defined by a U-shaped tubular member having a first arm 302 and a second arm 304 connected by a crossbar 306. The first arm 302 has a main section 308, a front end section 310 to which the crossbar 306 connects to, and a bend 312 between the main section 308 and the front end section 310. Similarly the second arm 304 has a main section 314, a front end section 316 and a bend 318 between them. In the example of FIG. 1 the front end sections 310, 316 are angled 90 degrees relative to the main sections 308, 314 so that the crossbar 306 is positioned below the plane formed by the main sections 308, 314, but in other examples, this angle may be greater or less than 90 degrees. The back ends 319 of the first arm 302 and the second arm 304 are attached to their respective joint hubs 360 as further described below.

The crossbar 306 may be integrally formed with the first arm 302 and the second arm 304 (e.g., a single tube is bent into the final shape of the seat portion 140) or the crossbar 306 can be separately formed and attached to the first arm 302 and the second arm 304.

The support frame 320 may also be formed as a U-shaped tubular member having a first arm 322 and second arm 324 connected by a crossbar 326. The first arm 322 has a main section 328, a distal end section 330 to which the crossbar 326 connects to, and a bend 332 between the main section 328 and the distal end section 330. Similarly the second arm 324 has a main section 334, a distal end section 336 and a bend 338 between them. In the example of FIG. 1 the distal end sections 330, 336 are angled 90 degrees relative to the main sections 328, 334 but in other examples, this angle may be greater or less than 90 degrees. The proximal ends 339 of the first arm 322 and the second arm 324 are rotatably attached to their respective joint hubs 360 as further described below.

The back ends 319 of the first arm 302 and the second arm 304 of the seat frame 300 may each be fixedly attached to a joint hub 360. As seen in FIGS. 3-6, each back end 319 may be inserted into an aperture 362 molded or otherwise formed in the front end of joint hub 360.

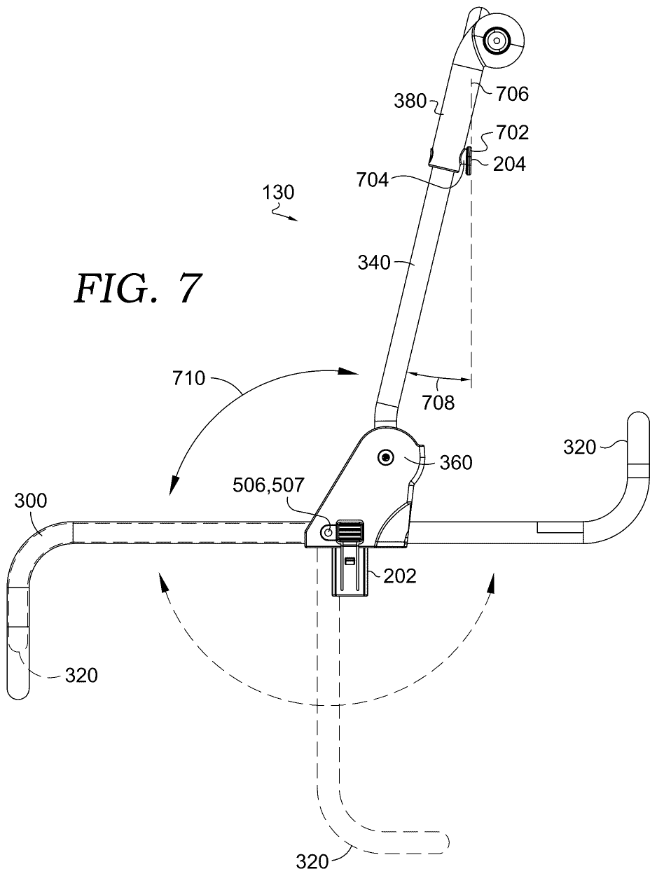

Adjacent to the aperture 362 is a channel 500 formed in the bottom of the joint hub 360 that extends through the joint hub 360 from front to back, with the channel 500 having an axis that runs parallel to the first arm 302 and the second arm 304 of the seat frame 300. The channel has a front opening 502 and a back opening 504. A pair of pivot holes 506 are formed along the channel wall 508, allowing a pin 507 or other suitable connector to rotatably connect and secure a proximal end 339 of the support frame 320 to the joint hub 360. In an embodiment, the pin 507 may also extend through the first arm and the second arm of the seat frame 300, securing the seat frame into place within the aperture 362 of the joint hub 360. As seen in FIG. 7, the pivoting connection in the channel 500 allows the support frame 320 to pivot or rotate 180 degrees between the stored position (FIG. 3) and the deployed position (FIG. 4) but prevents rotation beyond these positions. In other examples, the joint hubs 360 or support frame 320 may be configured to allow greater (e.g., more than 180 degrees, such as 181-240 degrees) or less (e.g., less than 180 degrees, such as 120-179 degrees) rotation of the support frame 320 relative to the joint hub 360.

While other configurations of the joint hub 360 are possible, the configuration in the example of FIGS. 3-6 may include several advantages. The single channel running front to back is simple to manufacture, and the channel, by largely surrounding or enclosing the proximal end of the support part, may also guard against a user's fingers or other body parts from being inadvertently caught or pinched between the joint hub and the proximal end while the support part is being rotated.

The joint hub 360 may include tabs or other suitable detent mechanisms for holding, such as through frictional engagement, resilient engagement, and compressive engagement the support frame 320 in each of the storage position and the deployed position. In other examples, a locking mechanism (not shown) may also be incorporated to require a user to unlock the support frame 320 from one or both positions.

As seen in FIG. 3 and FIG. 7, the U-shaped tubular member of the support frame 320 may dimensioned so that when the support frame 320 is in the stored position, the support frame 320 is nested within the U-shaped tubular member of the seat frame 300. Stated differently, in the stored position the main sections of the seat and support are substantially parallel and aligned in a common (e.g., horizontal) plane and the front ends of the seat are substantially parallel and aligned in a second common (e.g., vertical) plane with the front ends of the seat frame 300, with the bends of the support and the seat correspondingly aligned. In the example of FIGS. 3-6, in the stored position the support crossbar 3326 is vertically aligned with but spaced above the seat crossbar 306. This spacing between the crossbars allows for the support frame 320 to be rotated in and out of the stored position freely without mechanically interference, and also allows a user to comfortably grasp the crossbars to rotate the support frame 320 relative to the seat frame 300 while limiting a body part being caught or pinched between the crossbars during the rotational movement.

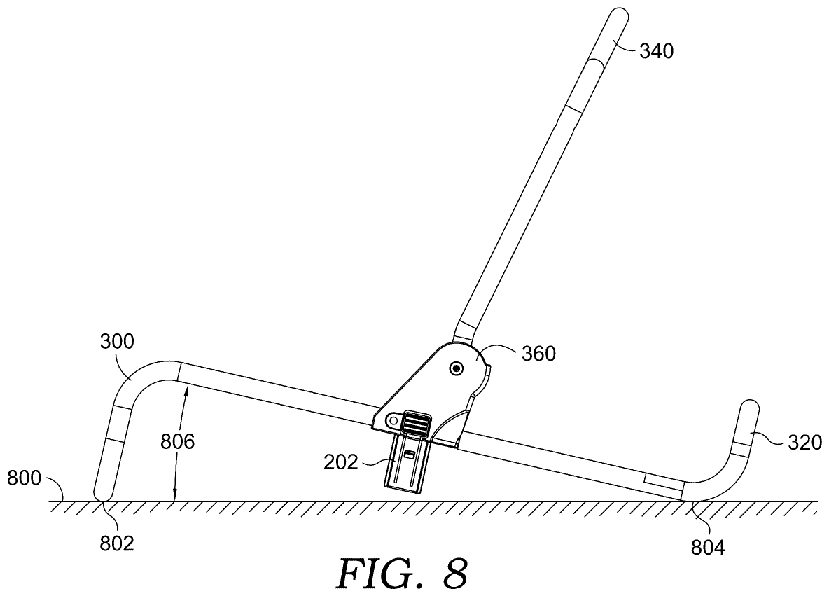

The backrest frame 340 may also comprise a generally tubular U-shaped member comprising a first arm 342 and a second arm 344 connected by a crossbar 346. The lower ends 348 of first arm 342 and the second arm 344 may each be attached to a ratchet hinge 364 of the joint hub, allowing the backrest frame 340 to be adjustably set to multiple angles relative to the seat frame 300. In the example of FIG. 3 (and as can also be see in the side view of FIGS. 7 and 8), the lower ends 348 are angled slightly relative to the rest of the first arm 342 and the second arm 344; in other examples the angle may be different or the arms can be straight from end to end. Additionally, in the example of FIG. 3, the axis of rotation of the ratchet hinges 364 is offset from the rotation axis 510 of the support frame 320, but in other examples these axes may be aligned. In some examples, the backrest frame 340 may be adjustable so that it can be rotated forward until it rests upon or is positioned over the seat frame 300, creating a more compacted position so that the backrest frame 340 does not protrude upwards when the wagon 100 is in its folded position.

In some examples, a canopy can be attached to the chair. For example, in FIG. 3 canopy attachments 380 may be positioned on the upper ends of the backrest first arm 342 and the backrest second arm 344 near the backrest crossbar 346. The canopy attachments 380 may include rotating hubs 390 to which canopy arms (not shown) can be attached, allowing the canopy to fan opened and closed.

As shown in FIG. 4, soft goods 400 may extend between the main sections 308, 314 to form a seating surface 402 of the chair 130. The soft goods 400 may be stretched between the main sections with a varying degree of tension and may be attached to the arms using any number of suitable known methods. For example, loops may be formed on each end of a section of fabric through which the first arm 302 and the second arm 304 can be inserted through, or the ends of a section of fabric can be attached to the first arm 302 and the second arm 304 using fasteners (e.g., rivets) or adhesive. Similarly, soft goods 404 may extend between the first arm 342 and the second arm 344 of the backrest frame 340 to form the backrest surface 406.

The joint hubs 360 each comprise a lower connector 202 that extends from the joint hub 360 in a downward direction. In the example of FIG. 1, the lower connector 202 may be in the form of a post that is generally straight and in the shape of a rectangular prism with chamfered edges. In other examples, the lower connector 202 may be slightly curved and/or have different cross-sectional profiles. A curved lower connector 202 may allow user to insert the chair 130 into the wagon 100 along a slight arc instead of holding the chair 130 vertically straight during the entire insertion process. The lower connector 202 may be hollow or solid, and may have an open or closed end. It is to be appreciated that attaching the lower connectors 202 to the chair may include integrally forming them with parts of the chair (such as the joint hub 360) as well as by mechanical securement, adhesives, bonding or other known methods.

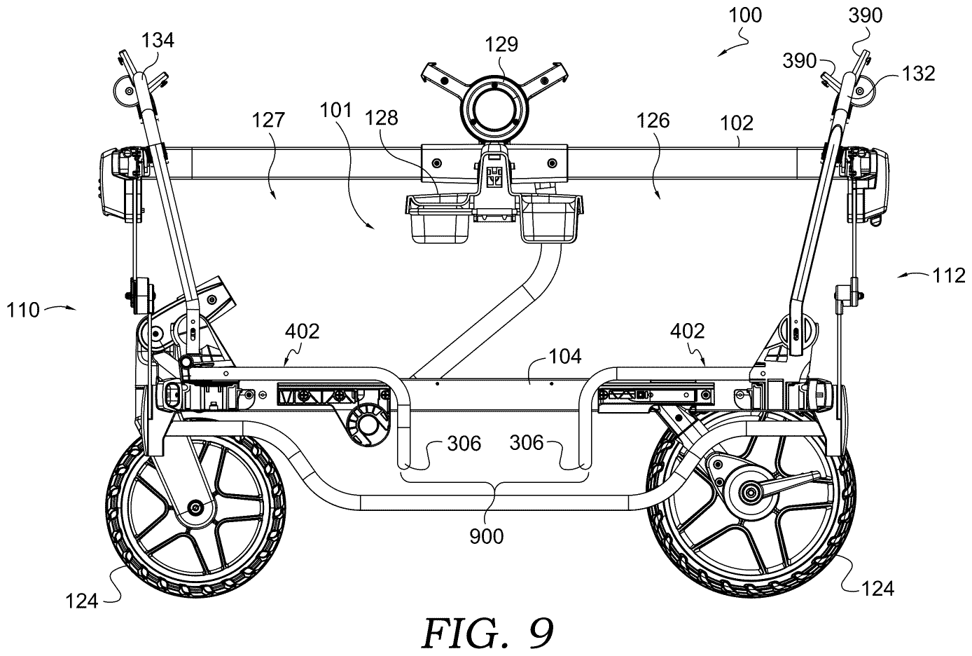

Turning back to FIGS. 1-2 and with reference to FIG. 9, when the support frame 320 is in the stored position, a chair 130 may be secured to the wagon 100 by sliding the lower connectors 202, which in the example of FIG. 2 are the posts 202 of each joint hub 360, into the lower receptacles 200 attached to the bottom of the wagon. It is to be appreciated that attaching the receptacles 200 to the wagon may include integrally forming them with parts of the wagon (such as the bottom frame 104) as well as by mechanical securement, adhesives, bonding or other known methods. The receptacles 200 may comprise apertures 206 aligned vertically and configured to fit with the posts 202. The chair 130 may be further secured to the wagon 100 by concurrently sliding the upper connectors 204 on the backrest frame 340 of the chair 130 into the upper receptacles 208 on the upper frame of the wagon 100. The upper connection points fix the distance between the backrest frame 340 and the top frame 102, limiting potential pinch points from being created between them when the wagon 100 is in motion or the chair 130 is being sat in. The space between the backrest frame 340 and the top frame 102 can be sized to accommodate a canopy attached to the backrest frame 340 when the canopy is folded and rotated to be positioned behind the backrest frame 340. In the example of FIG. 1 the apertures 206 are uncovered but they may be partially or completely covered in other examples.

In the example of FIG. 9, it can be seen that the frame of the wagon 100 may be configured so that soft goods attached to the frame form a footwell 900 in the lower surface of the wagon in the space between the first seating area 126 and the second seating area 127. As seen in FIG. 9, the front end sections 316 of each seat frame 300 can fit along the walls of the footwell 900, which may provide greater comfort for the person sitting in the chair 130 when it is secured in the wagon 100. As also seen in FIG. 9, the main sections of the first arm and the second arm of the seat and support may rest on top of the bottom frame 104 or the soft goods that form the bottom surface of the wagon 100 so that the weight of the chair 130 (and any items or persons resting on the chair 130) is supported.

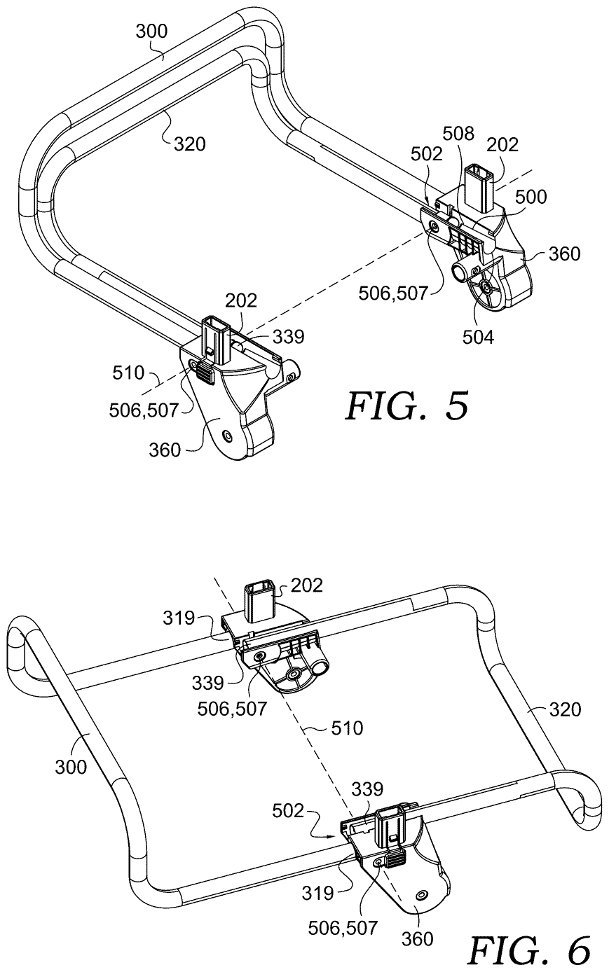

The lower connectors 202 may each include a locking mechanism to prevent the chair 130 from accidentally lifting out of the wagon. As seen in FIG. 5, the locking mechanism may be integrally formed on a side of the joint hub 360 and comprises a tooth 512 on a resilient lever 514 formed along one side of the lower connector 202. The lever 514 extends to the outer side of the joint hub and includes a button 516 on or near the free end of the lever 514. The tooth 512 may be retained by a corresponding side hole (not shown) in the interior wall of the aperture 206. Pressing the button 516 inwards (into the joint hub 360) depresses the lever 514 and shifts the tooth 512 inward until it is clear of the aperture side hole, allowing the lower connector 202 to be lifted out of the aperture 206. If a similar locking mechanism is provided on both joint hubs 360, a user would need to press the buttons 516 on each before being able to lift up the chair 130 out of the wagon 100.

As best seen in the side view of the chair 130 of FIG. 7, the upper connectors 204 may comprise a tab 702 attached to a post 704 that extends from a rear-facing surface of the backrest frame 340. The longitudinal axis 706 of the tab 702 is oriented at an angle 708 relative to the arms of the backrest frame 340, so that the longitudinal axis 706 is vertical when the backrest first arm 342, backrest second arm 344, and backrest surface 406, are at an angle 710 slightly more than 90 degrees from the seating surface 402. This allows the tab 702 to be properly oriented to more easily engage the upper receptacle 208 when the backrest frame 340 is in this angled position, which may be more comfortable than if the backrest surface 406 were oriented vertically (that is, 90 degrees relative to the seating surface 402) when the chair 130 is attached to the wagon 100 within the seating areas 126, 127. In examples, the angle 710 may be between 91 and 110 degrees, which may increase the comfort of a person seated in the chair 130 when the chair 130 is attached to the wagon 100. As seen in FIGS. 1 and 2, the tab 702 has a width (in the left-right direction) greater than the post 704, and is configured to be slidably received in the upper receptacle 208, which has a T-shaped slot with an upper opening for receiving the tab 702 and that, once engaged, prevents movement of the upper connector 204 in the horizontal plane (i.e., left-right and front-back movement) but allows for the upper connector 204 to be moveable in the vertical direction.

In the example of FIG. 1, the upper connector 204 is as attached to part of the canopy attachments 380 to the backrest frame 340, but in other examples the upper connector 204 may be attached to another part of the backrest frame 340. It is to be appreciated that attaching the upper connector 204 to the backrest frame 340 may include integrally forming the upper connector 204 with a component of the backrest frame 340 as well as by mechanical securement, adhesives, bonding or other known methods. The rotating hubs 390 are interior to the upper connectors 204 so that the canopy may be folded and rotated so that it nestles behind the backrest without interfering with the upper connectors 204.

As shown in FIGS. 1 and 2, the wagon 100 may be able to store two chairs 130 with their support frames 320 in the stored position, with one at or adjacent to the rear side 112 in the first seating area 126, and the other at or adjacent to the front side 110 in the second seating area 127, by having pairs of lower receptacles 200 and upper receptacles 208 on the front frame portion 118 and the rear frame portion 120. It is to be appreciated that the lower connectors 202 and the upper connectors 204 cannot respectively engage the lower receptacles 200 and the upper receptacles 208 when the support frame 320 of the chair 130 is in its deployed state. In the example FIG. 1, the lower receptacles 200 and the upper receptacles 208 are of the same kind and size on both ends, so that the two chairs 130 can be interchangeably attached to either end. In other examples, such as if a wagon 100 had attachable chairs 130 of different sizes, the connectors on the chairs 130 and receptacles on the wagon 100 can be differently sized or configured so that the each chair 130 can only be attached to its specific area of the wagon 100. Furthermore, one or more of the connectors or receptacles may be configured so that they can only be mated in a specific orientation to prevent a chair 130 from being attached to the wagon 100 in an improper or undesired orientation. In alternative examples, other combinations of mechanisms may be used to attach the chair 130 or chairs 130 to the wagon 100. For example, instead of the lower connector 202 extending from the chair 130, a post could extend from the bottom (or other surface) of the wagon and be received in a complementary component on the chair 130.

When the chair 130 is removed from the wagon 100, the support frame 320 may be rotated from its stored position into its deployed position before being placed on the ground or other flat surface. As shown in FIG. 8, when the support frame 320 is in the deployed position the chair 130 will rest upon a flat surface 800 with a front ground contact surface 802 in front of the seating surface 402 and backrest frame 340 and two back ground contact surfaces 804 behind the seating surface 402 and backrest frame 340. In the example of FIG. 8, the front contact surface is on the crossbar 306 of the seat frame 300 and the back ground contact surfaces 804 are on the bends 312. 318 and of support frame 320, resulting in the seating surface 402 being at an angle 806 relative to the flat surface 800. In examples, the angle 806 may be between 5 and 30 degrees, which may increase the comfort of a person seated in the chair 130. The components of the chair 130 may be dimensioned so that the connectors do not touch the flat surface 800. Because the front ground contact surface 802 and the back ground contact surfaces 804 are spaced apart in the front-to-back direction, a person may sit in the chair 130 with the upper back part angled at a wide variety of angles (e.g., upright or reclined) without the chair 130 losing stability and tipping over backwards. The width of the chair 130 (in the side-to-side direction) is also dimensioned so that the front ground contact surface 802 and back ground contact surfaces 804 are sufficiently spaced and/or wide enough so that lateral stability is sufficient across a range of reasonable operating conditions (e.g., a ground surface that is not perfectly flat or sloped).

Conversely, in examples the chair 130 may be configured so that the chair 130 is unstable if a user attempts to use the chair 130 on a flat surface without properly deploying the support frame 320 into the deployed position. For example, the chair of FIG. 1 may be configured so that when the support frame 320 is in the stored position, the chair's center of gravity is positioned behind the posts 202 of the joint hubs 360, so that if a user attempts to stand the chair 130 upright on the front ground contact surface 802 and the bottoms of the posts 202, the chair 130 will tip over backwards even before a user attempts to sit in it. Incorporating such a feature may discourage deploying or sitting in the chair 130 when the support frame 320 is not properly deployed, and can also prevent damage to the posts 202 through misuse.

In the example of FIG. 1, a joint hub crossbar 399 connects the two joint hubs 360 together. The joint hub crossbar 399 provides additional structural stability to the chair 130, particularly when a person is sitting in the chair 130 in the deployed position. In the example of FIG. 1, the joint hub crossbar 399 is a generally straight lateral tubular member with a consistent circular cross-section but in other examples it may be curved or have a different cross-section across its length.

In alternative examples, the leg portion can move from a stored position to a deployed position in ways other than rotation. For example, the joint hubs 360 of the chair 130 of FIG. 1 could be modified so that the proximal ends 339 of the support frame 320 can be slid in and out of both the front and back ends of the channel 500 of the joint hubs 360 to position the support frame 320 in the stored or the deployed position respectively. The support frame 320 may be held in place by an interference fit with the channel 500 or an appropriate locking or securement feature can be incorporated.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.
Clause 1. A chair removably connected to a wheeled conveyance, comprising: a seat comprising a front end and a back end; a support comprising a proximal end and a distal end; a first joint hub connecting the seat and the support; and a first connector configured to connect with a receiver on the wheeled conveyance; wherein: the support is moveable between a stored position and a deployed position; the seat and the support are configured to contact a surface when the support is in the deployed position; and the first connector is configured to removably connect the chair to the wheeled conveyance when the support is in the stored position.
Clause 2. The chair according to clause 1, wherein the seat has a first ground engaging portion at or adjacent to the front end.
Clause 3. The chair according to clause 2, wherein the support has a second ground engaging portion at or adjacent to the distal end.
Clause 4. The chair according to clause 3, wherein the second ground engaging portion is forward of the first joint hub when the support is in the stored position, and the second ground engaging portion is rearward of the first joint hub when the support is in the deployed position.
Clause 5. The chair according to clause 4, wherein the support is rotatable about a first pivot axis in the first joint hub between the stored position and the deployed position.
Clause 6. The chair according to clause 5, wherein the support is rotated 180 degrees between the stored position and the deployed position.
Clause 7. The chair according to any of clauses 1 to 6, wherein the chair has a first footprint when the support is in the stored position and a second footprint when the support is in the deployed position, with the second footprint being larger than the first footprint.
Clause 8. The chair according to any of clauses 2 to 7, wherein the seat comprises a seat surface, and the first ground engaging portion is spaced vertically below the seat surface.
Clause 9. The chair according to clause 8, wherein when the chair is positioned upon a surface when the support is in the deployed position, the seat surface is angled relative to the surface.
Clause 10. The chair according to clause 9, wherein when the chair is positioned on the surface the first connector does not touch the surface.
Clause 11. The chair according to any of clauses 1 to 10, wherein the chair further comprises a backrest connected to the seat.
Clause 12. The chair according to clause 11, wherein the backrest is adjustable between a folded, upright and laid-back position.
Clause 13. The chair according to clause 12, wherein the backrest is rotatably connected to the first joint hub.
Clause 14. The chair according to any of clauses 1 to 13, wherein the first connector comprises a post that extends from the first joint hub.
Clause 15. A method for storing a chair in wheeled conveyance, the chair comprising a support having a deployed state and a stored state, the chair having a first footprint in the deployed state that is larger than a second footprint in the stored state, the chair comprising a connector, comprising the steps of: converting the support from the deployed state to the stored state; and removably attaching the chair to the wheeled conveyance via the connector in a location where the chair is capable of being received in the stored state and incapable of being received in the deployed state.
Clause 16. The method according to clause 15, wherein the connector is a post, and the step of removably attaching comprises inserting the post into a receptacle in the wheeled conveyance.
Clause 17. The method according to clause 16, wherein the post extends downward from a bottom surface of the chair in the stored state.
Claim 18. The method according to clause 17, wherein the receptacle is located in a lower surface within a contained volume of the wheeled conveyance.
Claim 19. The method according to clause 18, wherein the chair and the contained volume are configured to allow a person to sit in the chair when the post is inserted into the receptacle.
Claim 20. A system comprising a wagon configured for transporting a child and a pair of detachable chairs; the wagon comprising: a wagon frame that can move between a collapsed and an open position; a first receptacle attached to the wagon frame; and a second receptacle attached to the wagon frame and spaced away from the first receptacle; each detachable chair comprising: a seat comprising a front end; a support rotatable between a stored position and a deployed position, wherein the front end and the support are configured to contact a flat horizontal surface when the support is in the deployed position; and a post extending from a bottom surface of the detachable chair; wherein: the post of each detachable chair can be received in either the first receptacle or the second receptacle when the support is in the stored position but not when the support is in the deployed position; and each detachable chair is capable of supporting the child when its post is received within the first receptacle or the second receptacle.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A chair removably connected to a wheeled conveyance, comprising:
a seat comprising a front end and a back end;
a support comprising a proximal end and a distal end;
a first joint hub connecting the seat and the support; and
a first connector configured to connect with a receiver on the wheeled conveyance;
wherein:
the support is moveable between a stored position and a deployed position;
the seat and the support are configured to contact a surface when the support is in the deployed position; and
the first connector is configured to removably connect the chair to the wheeled conveyance when the support is in the stored position.

2. The chair of claim 1, wherein the seat has a first ground engaging portion at or adjacent to the front end.

3. The chair of claim 2, wherein the support has a second ground engaging portion at or adjacent to the distal end.

4. The chair of claim 3, wherein the second ground engaging portion is forward of the first joint hub when the support is in the stored position, and the second ground engaging portion is rearward of the first joint hub when the support is in the deployed position.

5. The chair of claim 4, wherein the support is rotatable about a first pivot axis in the first joint hub between the stored position and the deployed position.

6. The chair of claim 5, wherein the support is rotated 180 degrees between the stored position and the deployed position.

7. The chair of claim 1, wherein the chair has a first footprint when the support is in the stored position and a second footprint when the support is in the deployed position, with the second footprint being larger than the first footprint.

8. The chair of claim 2, wherein the seat comprises a seat surface, and the first ground engaging portion is spaced vertically below the seat surface.

9. The chair of claim 8, wherein when the chair is positioned upon a surface when the support is in the deployed position, the seat surface is angled relative to the surface.

10. The chair of claim 9, wherein when the chair is positioned on the surface the first connector does not touch the surface.

11. The chair of claim 1, wherein the chair further comprises a backrest connected to the seat.

12. The chair of claim 11, wherein the backrest is adjustable between a folded, upright and laid-back position.

13. The chair of claim 12, wherein the backrest is rotatably connected to the first joint hub.

14. The chair of claim 1, wherein the first connector comprises a post that extends from the first joint hub.

15. A method for storing a chair in wheeled conveyance, the chair comprising a support having a deployed state and a stored state, the chair having a first footprint in the deployed state that is larger than a second footprint in the stored state, the chair comprising a connector, comprising the steps of:
converting the support from the deployed state to the stored state; and
removably attaching the chair to the wheeled conveyance via the connector in a location where the chair is capable of being received in the stored state and incapable of being received in the deployed state.

16. The method of claim 15, wherein the connector is a post, and the step of removably attaching comprises inserting the post into a receptacle in the wheeled conveyance.

17. The method of claim 16, wherein the post extends downward from a bottom surface of the chair in the stored state.

18. The method of claim 17, wherein the receptacle is located in a lower surface within a contained volume of the wheeled conveyance.

19. The method of claim 18, wherein the chair and the contained volume are configured to allow a person to sit in the chair when the post is inserted into the receptacle.

20. A system comprising a wagon configured for transporting a child and a pair of detachable chairs,
the wagon comprising:
a wagon frame that can move between a collapsed and an open position;
a first receptacle attached to the wagon frame; and
a second receptacle attached to the wagon frame and spaced away from the first receptacle;
each detachable chair comprising:
a seat comprising a front end;
a support rotatable between a stored position and a deployed position, wherein the front end and the support are configured to contact a flat horizontal surface when the support is in the deployed position; and
a post extending from a bottom surface of the detachable chair;
wherein:
the post of each detachable chair can be received in either the first receptacle or the second receptacle when the support is in the stored position but not when the support is in the deployed position; and
each detachable chair is capable of supporting the child when its post is received within the first receptacle or the second receptacle.
